(19) United States
(12) Patent Application Publication
(10) Pub. No.: US 2024/0362542 A1
(43) Pub. Date: Oct. 31, 2024

(54) COMPONENTS DEVIATION DETERMINATIONS

(71) Applicant: Hewlett-Packard Development Company, L.P., Spring, TX (US)

(72) Inventors: Abhishek Ghosh, Spring, TX (US); Manohar Lal Kalwani, Maharashtra (IN)

(73) Assignee: Hewlett-Packard Development Company, L.P., Spring, TX (US)

(21) Appl. No.: 18/683,948

(22) PCT Filed: Sep. 14, 2021
(86) PCT No.: PCT/US2021/050140

§ 371 Date: Feb. 15, 2024

(51) Int. Cl. G06N 20/00

(52) U.S. Cl. CPC G06N 20/00

(57) ABSTRACT

In an example, a non-transitory machine-readable storage medium storing instructions executable by a processor of a computing device to receive device usage data of an electronic device. Further, instructions may be executed by the processor to receive sensor data indicative of an internal state of the electronic device. The sensor data may include first data associated with a first characteristic of the internal state and second data associated with a second characteristic of the internal state. Furthermore, instructions may be executed by the processor to determine a deviation associated with a component of the electronic device by applying a machine learning model to the device usage data and the sensor data. The deviation may be associated with the first characteristic, the second characteristic, or both. Further, instructions may be executed by the processor to generate an alert notification based on the deviation.

### BACKGROUND

Electronic devices, such as desktop computers, laptop computers, point of sale systems, smartphones, or the like, may include a number of electronic components to perform various functions/operations. An example electronic component may include a central processing unit (CPU), a storage disk, a fan, a graphics card, or the like. Further, such electronic components may produce heat, sound, or both during operation. For example, an increase in load of the CPU (e.g., where the CPU generates heat) may increase a fan speed, which may in turn generate sound.

### BRIEF DESCRIPTION OF THE DRAWINGS

Examples are described in the following detailed description and in reference to the drawings, in which:

FIG. 1A is a block diagram of an example electronic device, including a processor to output an alert notification including a recommended action to reduce sound, temperature, or both of a component of the electronic device;

FIG. 1B is a block diagram of the example electronic device of FIG. 1A, depicting additional features;

FIG. 2 is a block diagram of an example computing environment, depicting the example electronic device of FIG. 1B in communication with a computing device;

FIG. 3A is a flowchart illustrating an example process for training a machine learning model based on historical device usage data and historical sensor data:

FIG. 3B is a flowchart illustrating an example process for determining a sound deviation, a temperature deviation, or both of a component of an electronic device by applying the trained machine learning model (e.g., of FIG. 3A) on real-time device usage data and real-time sensor data:

FIG. 4 is a block diagram of an example computing device including a non-transitory machine-readable storage medium, storing instructions to determine a deviation of a component associated with an electronic device; and

FIG. 5 is a block diagram of an example computing device including a non-transitory machine-readable storage medium, storing instructions to determine a machine learning model to estimate a sound deviation, a temperature deviation, or both of a component of an electronic device.

### DETAILED DESCRIPTION

Electronic devices, such as desktop computers, laptop computers, point of sale systems, smart phones, or the like may include numerous electronic components (e.g., a central processing unit (CPU), a battery, a storage disk, a fan, a graphics card, and other integrated circuits (ICs)) to perform various functions/operations. Such components may generate heat, sound, or both during the operation of the electronic device.

For example, users may often forget to shut down the electronic device, which may lead to components swelling because of overutilization of the components. Further, simultaneous execution of multiple applications on the electronic device may lead to an overutilization of the components. With the overutilization of the components along with the age of the electronic devices, the component may emit sound at different frequencies. For example, the storage disk may emit sound at a certain frequency with a specific decibel range.

Further, with the overutilization of the components along with the age of the electronic devices, the components may start to heat up. Different components may generate heat at different ranges. Such issues related to sound and temperature may continue to increase overtime, which may affect an operation efficiency of the electronic device or may result in a mechanical damage to the electronic device, for instance, when the sound or temperature exceeds a limit.

Examples described herein may provide a computing device that utilizes a machine learning model to determine a deviation (e.g., a sound deviation, a temperature deviation, or the like) of a component of an electronic device. The computing device may be a server that is communicatively connected to the electronic device via a network. The computing device may obtain historical device usage data (e.g., central processing unit (CPU) usage data, application usage data, device charging data, device location data, fan speed, and the like) and historical sensor data (e.g., device sound data and device temperature data) associated with different components of the electronic device. Further, the computing device may process the historical device usage data and the historical sensor data to generate a train dataset and a test dataset. Furthermore, the computing device may build a set of machine learning models with the train dataset to determine the deviation of the component. Also, the computing device may test the trained set of machine learning models with the test dataset. In addition, the computing device may select the machine learning model having a maximum accuracy from the set of trained and tested machine learning models to estimate the deviation of the component.

During operation, the computing device may receive real-time device usage data and real-time sensor data associated with the electronic device. Further, the computing device may determine the deviation of the component by applying the selected machine learning model to the real-time device usage data and the realtime sensor data. Furthermore, the computing device may generate an alert notification based on the deviation. The alert notification may also include a recommended action/process to reduce the sound, the temperature, or both.

Thus, examples described herein may collect components' sound data and temperature data and utilize the machine learning model to classify anomaly in the sound and the temperature of the components. Further, examples described herein may prompt users with details of the components that has the underlying issues with respect to the sound and the temperature (i.e., the sound or the temperature crossing a respective threshold) and also prompt the users with recommended actions to proactively address the issues. Thus, examples described herein may intelligently identify and predict aforementioned issues with the components, which may avoid failure of the components or the electronic device.

In the following description, for purposes of explanation, numerous specific details are set forth in order to provide a thorough understanding of the present techniques. However, the example apparatuses, devices, and systems, may be practiced without these specific details. Reference in the specification to “an example” or similar language means that a particular feature, structure, or characteristic described may be included in at least that one example but may not be in other examples.

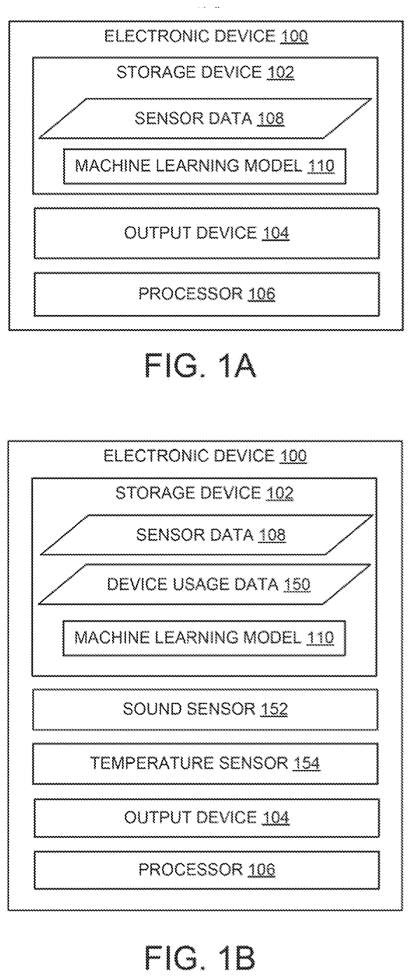

Turning now to the figures, FIG. 1A is a block diagram of an example electronic device 100, including a processor 106 to output an alert notification including a recommended action to reduce sound, temperature, or both of a component of electronic device 100. Example electronic device 100 may include a desktop computer, a notebook computer, a tablet computer, a smartphone, or the like.

As shown in FIG. 1A, electronic device 100 includes a storage device 102, an output device 104, and processor 106. Storage device 102 stores sensor data 108 associated with electronic device 100, Further, electronic device 100 includes a machine learning model 110 that is stored in storage device 102. In other examples, sensor data 108 and machine learning model 110 can be stored in separate storage devices associated with electronic device 100.

In an example, machine leaning model 110 may be trained and tested using historical device usage data and historical sensor data to determine a sound deviation, a temperature deviation, or both of a component of electronic device 100. Further, machine leaning model 110 may be trained and tested using the historical device usage data and the historical sensor data to recommend an action corresponding to the determined sound deviation, the temperature deviation, or both. In such examples, machine leaning model 110 may be trained and tested in a server (e.g., a cloud-based server, Software as a Service (SaaS)-based server, or the like). Further, electronic device 100 may receive trained and tested machine leaning model 110 from the server.

During operation, processor 106 may retrieve stored sensor data 108 for a period in response to receiving a trigger event (e.g., a user login event). In an example, sensor data 108 may include device sound data and device temperature data. In an example, sensor data 108 may be associated with a single component or multiple components of electronic device 100. For example, sensor data 108 may include sound data associated with a fan, a solid-state drive, and the like. In another example, sensor data 108 may include temperature data associated with a CPU, a hard disk drive, a battery, and the like. Further, processor 106 may apply machine learning model 110 to sensor data 108 to:
classify retrieved sensor data 108,
identify a component of electronic device 100 that generates sound, temperature, or both using the classified sensor data,
determine that the sound, temperature, or both associated with the component is to impact a performance of electronic device 100, and
in response to the determination, determine a recommended action to reduce the sound, the temperature, or both.

In an example, processor 106 may apply machine learning model 110 to sensor data 108 to filter sensor data 108 to remove ambient sound and ambient temperature from retrieved sensor data 108 and classify filtered sensor data 108 into a group of categories. In an example, sensor data 108 associated with a category in the group of categories may belong to the component of electronic device 100. The category may include the device sound data, device temperature data, or both specific to the component. For example, retrieved sensor data 108 may be classified into a first category that is specific to a CPU, a second category that is specific to a battery, and the like.

Further, processor 106 may output an alert notification including the recommended action via output device 104. In an example, processor 106 may output the alert notification via a defined policy. An example alert notification may include, but not limited to, a visual alert outputted via a visual output device (e.g., a display device), an audible alert outputted via a speaker, a haptic alert outputted via a tactile feedback device (e.g., a vibrator), data that can be sent via a communication interface to an external monitoring device, or any combination thereof. An example recommended action may include a suggestion to close an active application (e.g., to reduce load), to power off the electronic device, to replace a component, and the like.

FIG. 1B is a block diagram of example electronic device 100 of FIG. 1A, depicting additional features. For example, similarly named elements of FIG. 18 may be similar in structure and/or function to elements described with respect to FIG. 1A. As shown in FIG. 18, electronic device 100 includes a sound sensor 152 to record device sound data associated electronic device 100. For example, sound sensor 152 may include a microphone. The microphone may capture noise that is generated within the electronic device (e.g., noise generated by internal components) and external to the electronic device (e.g., user's voice). Further, electronic device 100 includes a temperature sensor 154 to record device temperature data associated with electronic device 100. Multiple temperature sensors can be used to determine temperature associated with different components.

For example, sound from each component of electronic device 100 may be captured through sound sensor 152 and then transformed to digital bytes and number values of decibel of sound. Further, the sound from sound sensor 152 may be stored (e.g., using python package sound device and scipy.io.wavfile) and further classification model (e.g., Support Vector Machine (SVM)) may confirm regarding sound emitted from electronic device 100. Further, temperature sensor 154 may capture components' temperature and may be transformed to numeric data in consistent units that may provide the information regarding device components' temperature.

Further, storage device 102 includes device usage data 150. During operation, processor 106 may combine device usage data 150 (e.g., application usage data) and sensor data 108 to identify load on the components that can enhance accuracy in predicting components' anomalies in correlation to the sound and temperature data. In an example, processor 106 may retrieve device usage data 150 for the period from storage device 102. For example, device usage data 150 may include CPU usage data, application usage data, device charging data, device location data, fan speed, device usage time, device age, or any combination thereof. Further, processor 106 may apply machine learning model 110 to sensor data 108 and device usage data 150 to determine that the sound, the temperature, or both associated with the component impacts the performance of electronic device 100.

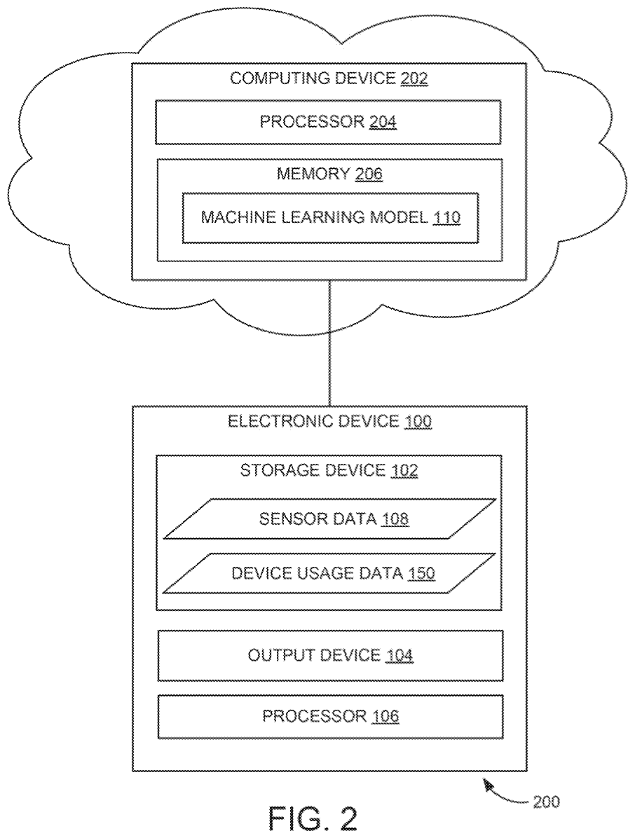

FIG. 2 is a block diagram of an example computing environment 200, depicting example electronic device 100 of FIG. 1B in communication with a computing device 202. For example, similarly named elements of FIG. 2 may be similar in structure and/or function to elements described with respect to FIG. 1B. In the example shown in FIG. 2, machine learning model 110 may be implemented as part of computing device 202. Example computing device 202 may be a cloud-based server. Further, computing device 202 includes a processor 204 and a memory 206. In the example shown in FIG. 2, memory 206 includes machine learning model 110.

During operation, computing device 202 may receive sensor data 108 and device usage data 150 from electronic device 100. Further, processor 204 may apply machine learning model 110 to received sensor data 108 and device usage data 150 to determine a sound deviation, a temperature deviation, or both of electronic device 100. Furthermore, processor 204 may determine a recommended action based on the determined sound deviation, the temperature deviation, or both. Upon determining the recommended action, processor 204 may send an alert notification including the recommended action to electronic device 100. In this example, processor 106 of electronic device 100 may receive the alert notification and output the alert notification via output device 104.

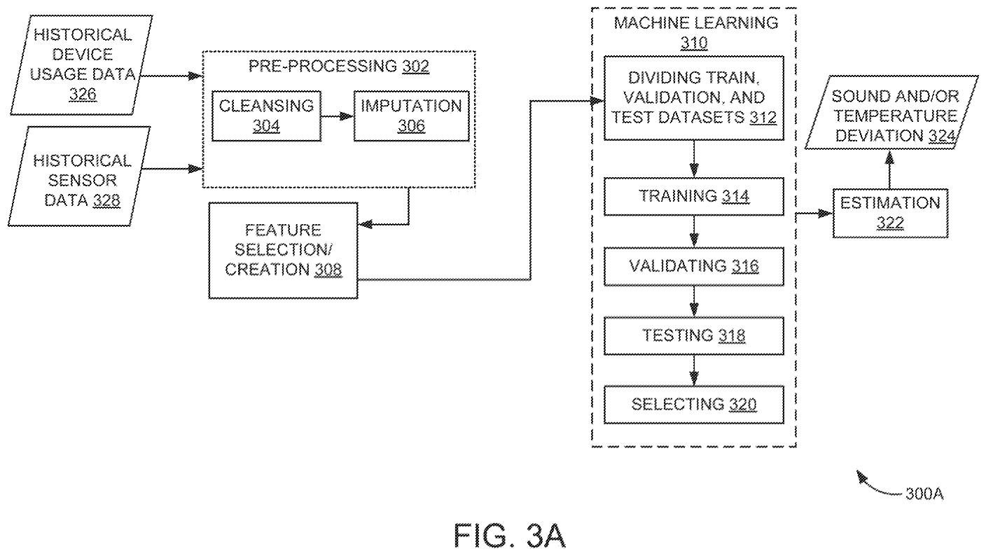

FIG. 3A is a flowchart illustrating an example process 300A for training a machine learning model based on historical device usage data 326 and historical sensor data 328. In one example, process 300A may be implemented in a computing device (e.g., a cloud-based server). At 302, historical device usage data 326 and historical sensor data 328 associated with an electronic device are received from the electronic device.

Further at 302, historical device usage data 326 and historical sensor data 328 are pre-processed. In one example, pre-processing historical device usage data 326 and the historical sensor data 328 may include cleansing the data (e.g., at 304), imputing the data (e.g., at 306), or any combination thereof. In an example, cleansing the data may include detecting and replacing an outlier value of a variable in historical device usage data 326 and historical sensor data 328. In another example, cleansing the data may include normalizing a value of a variable in historical device usage data 326 and historical sensor data 328. Further, historical device usage data 326 and historical sensor data 328 may be imputed for any missing data value, invalid data value, or scaling a data value. In this example, missing or invalid data values can be processed to impute values to replace the missing or invalid data values. In other words, historical device usage data 326 and historical sensor data 328 may be imputed to insert estimates for missing values that may have minimal impact on the analysis method. For example, historical device usage data 326 and historical sensor data 328 may be imputed through different statistical processes such as mean, previous entry, next entry, automated method (e.g., mice in R), and the like.

Further, at 308, a set of features (e.g., feature vectors) with a plurality of parameters (e.g., that are capable of being used to train the set of machine learning models) is selected or generated from the pre-processed historical device usage data and the pre-processed sensor data. At 310, a machine learning model is built with the cleansed and imputed data with the selected feature vectors. In an example, the machine learning model may be built as described in blocks 312, 314, 316, 318, and 320. At 312, the cleansed and imputed data is divided into training data, validation data, and test data. For example, the cleansed and imputed data may be divided into 60% of training data, 20% of validation data, and 20% of test data. In other words, first 60% entries may be provided as the training data, next 20% entries may be provided as the validation data, and last 20% entries may be provided as the test data.

At 314, multiple machine learning models are built with 60% training data. At 316, the machine learning models are validated with 20% validation data. In one example, the machine learning models may be tuned based on the validation. At 318, upon validating the machine learning models, the machine learning models are tested with 20% test data.

At 320, a machine learning model having a high accuracy is selected from the trained and tested machine learning models. In some examples, the selected machine learning model can be stored in a low latency database. The low latency database may facilitate in querying of the stored machine learning model with minimal delay (i.e., minimum latency), for instance, via a representational state transfer API (REST API). At 322, the selected machine learning model is applied on real-time device usage data and real-time sensor data received from the electronic device to estimate a sound deviation, a temperature deviation, or both (e.g. 324) of the electronic device. An example process to estimate the sound deviation, the temperature deviation, or both of the electronic device is described in FIG. 3B.

FIG. 3B is a flowchart illustrating an example process 300B for determining a sound deviation, temperature deviation, or both of a component of the electronic device by applying the trained machine learning model (e.g., of FIG. 3A) on realtime device usage data 350A and real-time sensor data 350B. In the example shown in FIG. 3B, process 300B may be implemented in a computing device (e.g., a cloud-based server). At 352, real-time device usage data 350A and real-time sensor data 350B for a period are received from the electronic device and received real-time device usage data 350A and real-time sensor data 350B may be pre-processed. In one example, pre-processing real-time device usage data 350A and real-time sensor data 3508 may include cleansing the data, imputing the data, or any combination thereof. Example device usage data and device components' sound data with an associated noise indicator is depicted in table 1 and example device components' temperature data with an associated heat indicator is depicted in table 2.

TABLE 1

| | Fan | | No. of | Hard | Sensor | Sensor | Sensor | Mic |
|---|---|---|---|---|---|---|---|---|
| Noise | speed | Device | apps | disk | CPU | fan | hard | sound |
| indicator | (RPM) | age | running | type | sound | sound | disk | data |
| 1 | 5444 | 5 | 45 | HDD | 30 | 40 | 33 | Yes |
| 1 | 5109 | 5 | 36 | HDD | 41 | 35 | 50 | Yes |
| 1 | 6864 | 3 | 27 | HDD | 40 | 38 | 31 | Yes |
| 0 | 1111 | 2 | 7 | SSD | 19 | 13 | 25 | No |
| 0 | 1741 | 1 | 8 | SSD | 16 | 21 | 20 | No |
| 0 | 1628 | 2 | 13 | SSD | 14 | 20 | 22 | No |

TABLE 2

| Heat | CPU | Battery | Hard Drive |
|---|---|---|---|
| Indicator | temperature | Temperature | Temperature |
| 1 | 73 | 38 | 52 |
| 1 | 70 | 38 | 61 |
| 1 | 59 | 28 | 66 |
| 0 | 50 | 20 | 11 |
| 0 | 40 | 20 | 43 |
| 0 | 40 | 20 | 7 |

In the example table 1, the device usage data may include data associated with various parameters such as a fan speed, device age, location identifier, number of applications running, hard disk type, number of user logins, device booting issue, and the like. Further, in the example table 1, the device sound data (i.e., device components' sound data) may include data associated with various parameters such as a CPU sound, fan sound, hard disk sound, microphone-captured sound data, and the like. Also, table 1 depicts a noise indicator value corresponding to different values associated with the device usage data and the device sound data. The noise indicator may be set as normal sound/moderately noisy/highly noisy for sound related issues. In other examples, the noise indicator value of “0” may indicate that the sound deviation is normal and the noise indicator value of “1” may indicate that the sound deviation is above a threshold.

In the example table 2, the device temperature data (i.e., device components' temperature data) may include data associated with various parameters such as CPU temperature, battery temperature, hard drive temperature, and the like. Also, table 2 depicts a heat indicator value corresponding to different values associated with the device usage data and the device sound data. The heat indictor may be set as normal heat/moderately heated/highly heated for temperature related issues. In other examples, the heat indicator value of “0” may indicate that the temperature deviation is normal and heat indicator value of “1” may indicate that the temperature deviation is above a threshold.

At 354, a set of features is created/selected for the pre-processed data. Example features (e.g., fan speed, device age, sensor hard disk, and CPU temperature) selected from the pre-processed data of tables 1 and 2 is depicted below in table 3.

TABLE 3

| Fan Speed (RPM) | Device age | Sensor hard disk | CPU temperature |
|---|---|---|---|
| 5444 | 5 | 33 | 73 |
| 5109 | 5 | 50 | 70 |
| 6864 | 3 | 31 | 59 |

At 356, the machine learning model, as selected at block 320 of FIG. 3A, is applied to the device usage data and the sensor data to:
determine the sound deviation, temperature deviation, or both (e.g., 324) of the electronic device, and
determine a recommended action based on the sound deviation, temperature deviation, or both.

In an example, when the sound deviation, temperature deviation, or both of the electronic device is determined as noisy, heated, or both (e.g., as shown in block 358), an alert notification including the recommended action to reduce sound, temperature, or both of the electronic device is generated and sent to the electronic device, at 360. In another example, when the sound deviation, temperature deviation, or both of the electronic device is determined as normal (i.e., the sound deviation, the temperature deviation, or both are within respective thresholds, as shown in block 362), no action may be initiated, at 364.

In the examples described herein, the electronic device may make a REST API call at frequent intervals or at a new user login to the electronic device. Upon receiving the REST API call, the computing device may obtain the real-time device usage data and the real-time sensor data from the electronic device. Further, the computing device may communicate with the low latency database, via an API call, for predicting the device components' sound deviation, temperature deviation, or both. Furthermore, the estimated results with suggested actions and measures to reduce the sound deviation, temperature deviation, or both obtained from the low-latency database may be prompted back to the electronic device. In an example, the recommendations due to the impact of noise and temperature can be configured in another database or metadata may be retrieved or mapped based on a noise/heat factor predicted by the machine learning model based on rule-based approach and prompted to user as necessary.

Thus, examples described herein may enable to build an artificial intelligence driven alert mechanism to predict and prompt users to reduce the sound, the temperature, or both of the electronic device. Examples described herein may also enhance life span of the electronic device and user experience.

The processes depicted in FIGS. 3A and 3B represent generalized illustrations, and those other processes may be added, or existing processes may be removed, modified, or rearranged without departing from the scope and spirit of the present application. In addition, the processes may represent instructions stored on a computer-readable storage medium that, when executed, may cause a processor to respond, to perform actions, to change states, and/or to make decisions. Alternatively, the processes may represent functions and/or actions performed by functionally equivalent circuits like analog circuits, digital signal processing circuits, application specific integrated circuits (ASICs), or other hardware components associated with the system. Furthermore, the flow charts are not intended to limit the implementation of the present application, but rather the flow charts illustrate functional information to design/fabricate circuits, generate machine-readable instructions, or use a combination of hardware and machine-readable instructions to perform the illustrated processes.

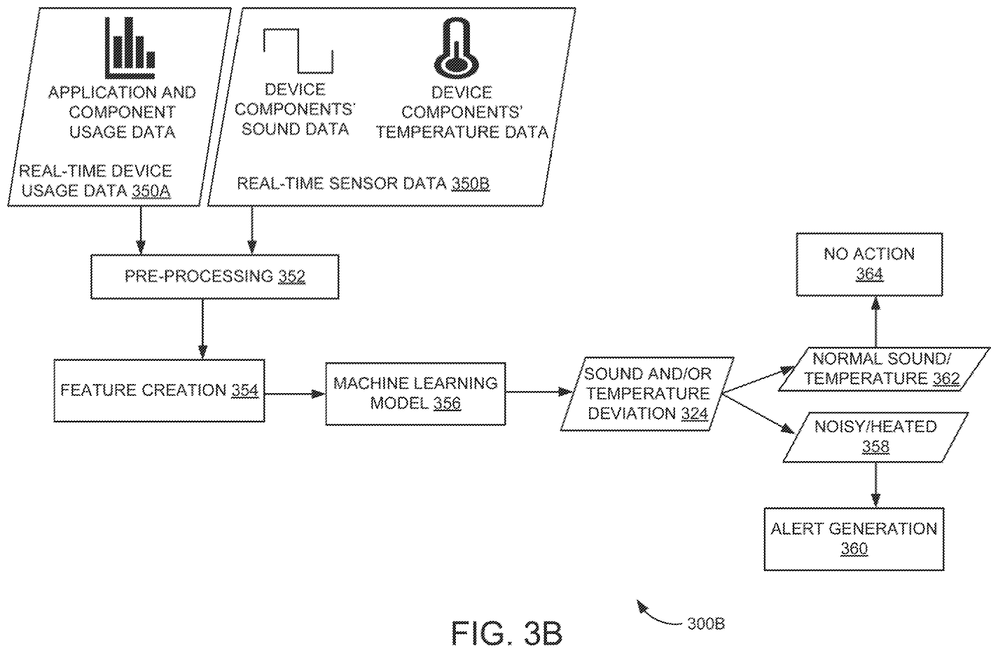

FIG. 4 is a block diagram of an example computing device 400 including a non-transitory machine-readable storage medium 404, storing instructions to determine a deviation of a component associated with an electronic device. In an example, computing device 400 may be a server operating in a cloud computing system, a server configured in a Software as a Service (SaaS) architecture, or the like. An example electronic device may be a desktop computer, a laptop computer, a point-of-sale system, a smartphone, or the like.

Further, computing device 400 may be communicatively connected to the electronic device via a network. Example network can be a managed Internet protocol (IP) network administered by a service provider. For example, the network may be implemented using wireless protocols and technologies, such as Wi-Fi, WiMax, and the like. In other examples, the network can also be a packet-switched network such as a local area network, wide area network, metropolitan area network, Internet network, or other similar type of network environment. In yet other examples, the network may be a fixed wireless network, a wireless local area network (LAN), a wireless wide area network (WAN), a personal area network (PAN), a virtual private network (VPN), intranet, or other suitable network system and includes equipment for receiving and transmitting signals.

Computing device 400 includes a processor 402 and machine-readable storage medium 404 communicatively coupled through a system bus. Processor 402 may be any type of central processing unit (CPU), microprocessor, or processing logic that interprets and executes machine-readable instructions stored in machine-readable storage medium 404.

Machine-readable storage medium 404 may be a random-access memory (RAM) or another type of dynamic storage device that may store information and machine-readable instructions that may be executed by processor 402. For example, machine-readable storage medium 404 may be synchronous DRAM (SDRAM), double data rate (DDR), Rambus® DRAM (RDRAM), Rambus® RAM, and the like, or storage memory media such as a floppy disk, a hard disk, a CD-ROM, a DVD, a pen drive, and the like. In an example, machine-readable storage medium 404 may be a non-transitory machine-readable medium, where the term “non-transitory” does not encompass transitory propagating signals. In an example, machine-readable storage medium 404 may be remote but accessible to computing device 400.

Machine-readable storage medium 404 stores instructions 406, 408, 410, and 412, Instructions 406 may be executed by processor 402 to receive device usage data associated with the electronic device, for instance, via the network. For example, the device usage data may include central processing unit (CPU) usage data, application usage data, device charging data, device location data, fan speed data, device usage time data, device age data, or any combination thereof.

For example, the CPU usage data may include data representing the electronic device's usage of processing resources, the amount of work handled by a CPU of the electronic device, and the like. The application usage data may include data indicating frequently used applications and track the number of concurrent applications during user sessions. The device charging data may include data indicating a connection or disconnection of the electronic device to an external power supply (i.e., time durations of charging), a number of charging and discharging cycles of a battery associated with the electronic device, and the like.

The device location data may be used to determine a location of the electronic device. The location data may include global positioning system (GPS) information (e.g., latitude and longitude data) corresponding to the location of the electronic device. The location data may be captured using a sensor (e.g., a GPS sensor) in the electronic device. The captured location data can be fed to a geo location application programming interface (API) (e.g., a Google map API) to identify public or private spaces.

The fan speed data may indicate a speed of a fan, which may be measured in revolutions per minute or RPMI The higher the RPM rating, the faster the fan spins. Further, the higher the RPM rating, the louder the fan may make noise. The device usage time data may indicate an amount of time or a time duration during which the electronic device is being used. The device age data may indicate the age of the electronic device (i.e., measured from manufactured date of the electronic device).

Instructions 408 may be executed by processor 402 to receive sensor data indicative of an internal state of the electronic device. In an example, the sensor data may include first data associated with a first characteristic of the internal state and second data associated with a second characteristic of the internal state. For example, the first data may be sound data and the second data may be temperature data associated with various components of the electronic device. In this example, the first characteristic of the internal state may be associated with sound and the second characteristic of the internal state may be associated with temperature. In an example, instructions to receive the device usage data and the sensor data may include instructions to receive the device usage data and the sensor data associated with the electronic device at a periodic interval or in response to a user login event to the electronic device (e.g., when a user logs in to the electronic device). Further, computing device 400 may receive the device usage data and the sensor data of the electronic device via an API call, for instance.

Instructions 410 may be executed by processor 402 to determine the deviation associated with the component of the electronic device by applying a machine learning model to the device usage data and the sensor data. In an example, the deviation may be associated with the first characteristic, the second characteristic, or both. The “machine-learning model” may refer to a computer representation that can be tuned (e.g., trained) based on inputs to approximate unknown functions. In particular, the term “machine-learning model” can include a model that utilizes methods to learn from, and make predictions on, known device usage data and the sensor data by analyzing the known device usage data and the sensor data to learn to generate an output (e.g., the sound deviation, the temperature deviation, or the like) that reflect patterns and attributes of the known device usage data and the sensor data.

For instance, the machine learning model may be a supervised machine learning model that implements a classification method such as a random forest, XG boost, logistic regression, or the like. In other examples, the machine-learning model can include, but not limited to, a decision tree, support vector machine, Bayesian network, dimensionality reduction algorithm, artificial neural network, and deep learning. Thus, the machine-learning model makes high-level abstractions in the device usage data and the sensor data by generating data-driven predictions or decisions from the inputted device usage data and the sensor data.

In an example, instructions to determine the deviation associated with the component may include instructions to apply the machine learning model to the device usage data, the first data, and the second data to:
determine the deviation of the component by comparing a difference between the received first data associated with the first characteristic of the component and first reference data based on the device usage data,
determine the deviation of the component by comparing a difference between the received second data associated with the second characteristic of the component and second reference data based on the device usage data, or
a combination thereof.

In an example, the first reference data may refer to an acceptable limit for the first characteristic (e.g., an acceptable sound limit) based on the device usage (e.g., a CPU usage). The second reference data may refer to an acceptable limit for the second characteristic (e.g., an acceptable temperature limit) based on the device usage (e.g., the CPU usage). In an example, instructions to determine the deviation associated with the component may include instructions to:
correlate the device usage data with the first data and the second data, and
determine the deviation associated with the component by applying the machine learning model to the device usage data, the first data, and the second data based on the correlation.

For example, the device usage data may be correlated in time with the first data and the second data, for instance, to identify the first data and the second data corresponding to the device usage data. Instructions 412 may be executed by processor 402 to generate an alert notification based on the determined deviation. In an example, the alert notification may include a recommended action to reduce the deviation associated with the component, replace the component, or a combination thereof. Further, the alert notification may be sent to the electronic device when the determined deviation exceeds a threshold.

The recommended action may depend on the component emitting sound, temperature, or both. In an example, a set of recommended actions (e.g., recommended approaches and measures) can be configured in computing device 400 (e.g., in a storage device associated with computing device 400). Further, the set of recommended actions may be mapped to different levels of sound deviations, temperature deviations, or both based on a rule-based approach, for instance. For example, different levels of sound deviations may include normal sound, moderate noise, and high noise and different levels of temperature deviations may include normal heat, moderate heat, and high heat.

Further, the recommended action corresponding to the determined level of sound deviation, temperature deviation, or both may be retrieved from the set of recommended actions and sent to the electronic device. For example, a first recommended action may be retrieved when the deviation associated with the component is greater than a first threshold, a second recommended action may be retrieved when the deviation associated with the component is greater than a second threshold, and the like. The recommendations can be user-defined. Further, the sound/temperature deviations and/or the set of recommended actions may be displayed on a user interface (e.g., a display device) of the electronic device.

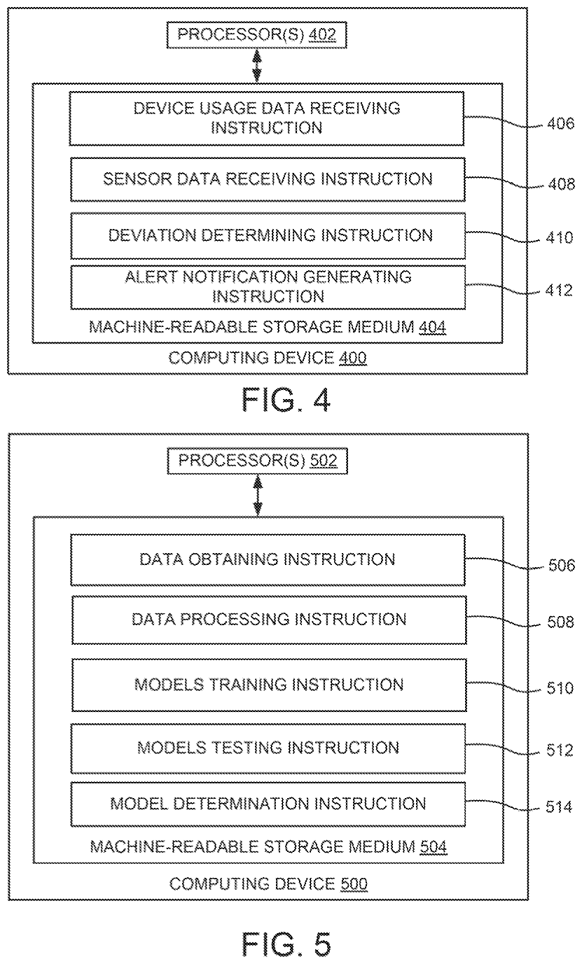

FIG. 5 is a block diagram of an example computing device 500 including a non-transitory machine-readable storage medium 504, storing instructions to determine a machine learning model to estimate a sound deviation, a temperature deviation, or both of a component of an electronic device, Computing device 500 includes a processor 502 and machine-readable storage medium 504 communicatively coupled through a system bus, Processor 502 may be any type of central processing unit (CPU), microprocessor, or processing logic that interprets and executes machine-readable instructions stored in machine-readable storage medium 504.

Machine-readable storage medium 504 may be a random-access memory (RAM) or another type of dynamic storage device that may store information and machine-readable instructions that may be executed by processor 502. For example, machine-readable storage medium 504 may be synchronous DRAM (SDRAM), double data rate (DDR), Rambus® DRAM (RDRAM), Rambus® RAM, and the like, or storage memory media such as a floppy disk, a hard disk, a CD-ROM, a DVD, a pen drive, and the like. In an example, machine-readable storage medium 504 may be a non-transitory machine-readable medium, where the term “non-transitory” does not encompass transitory propagating signals. In an example, machine-readable storage medium 504 may be remote but accessible to computing device 500.

Machine-readable storage medium 504 stores instructions 506, 508, 510, 512, and 514. Instructions 506 may be executed by processor 502 to obtain historical device usage data and historical sensor data of an electronic device. In this example, the historical device usage data and the historical sensor data associated with multiple components of the electronic device may be obtained over a period. For example, the historical device usage data may include processor usage data, device charging data, device usage time, or any combination thereof. Further, the historical sensor data may include device sound data (e.g., device components' sound data) and device temperature data (e.g., device components' temperature data).

Instructions 508 may be executed by processor 502 to process the historical device usage data and the historical sensor data to generate a train dataset and a test dataset. Instructions 510 may be executed by processor 502 to train a set of machine learning models, based on the train dataset, to estimate a sound deviation, a temperature deviation, or both of the component of the electronic device. An example component may be a CPU, a storage disk (e.g., a hard disk drive, a solid-state drive, or the like), a fan, a battery, or the like.

In an example, instructions to process the historical device usage data and the historical sensor data to generate the train dataset and the test dataset may include instructions to:
correlate the historical device usage data with the historical sensor data, and
generate the train dataset and the test dataset based on the correlation.

In an example, the historical device usage data may be correlated in a time series with the historical sensor data to identify historical sensor data values corresponding to historical device usage data values. For example, historical CPU usage data may be correlated in a time series with the historical temperature data to identify a temperature value of the CPU corresponding to an amount of the CPU utilization. Instructions 512 may be executed by processor 502 to test the trained set of machine learning models with the test dataset. In an example, prior to testing the trained set of machine learning models, machine-readable storage medium 504 may store instructions to validate the trained machine learning models to tune an accuracy of the trained machine learning models based on a validation dataset of the processed historical device usage data and the historical sensor data. Thus, a feedback mechanism through the test dataset and the validation dataset can be built to confirm the correctness of the machine learning models and fine tune the accuracy of the machine learning models, respectively.

In an example, instructions to train the set of machine learning models may include instructions to train the set of machine learning models to:
classify the historical sensor data to identify data associated with the component, and
estimate the sound deviation, the temperature deviation, or both associated with the component of the electronic device using the classified historical sensor data and the historical device usage data of the train dataset.

Instructions 514 may be executed by processor 502 to determine a machine learning model from the set of trained and tested machine learning models to estimate, in real-time, the sound deviation, the temperature deviation, or both associated with the component.

In an example, instructions to determine the machine learning model from the set of tested machine learning models to estimate the sound deviation, the temperature deviation, or both may include instructions to:
determine the machine learning model having a maximum accuracy from the set of tested machine learning models to:
   identify the component of the electronic device that generates sound, temperature, or both using real-time sensor data, and
   estimate the sound deviation, the temperature deviation, or both associated with the component for real-time device usage data and the real-time sensor data. In an example, the real-time device usage data may indicate a load on the component that impacts the sound, the temperature, or both associated with the component.

Further, machine-readable storage medium 504 may store instructions to:
receive real-time device usage data and real-time sensor data associated with the electronic device,
estimate the sound deviation, the temperature deviation, or both associated with the component by analyzing the real-time device usage data and the real-time sensor data using the determined machine learning model,
generate an alert notification based on the sound deviation, the temperature deviation, or both, and
send the alert notification to the electronic device.

For example, consider that the device usage data indicates that the electronic device is executing 10 applications simultaneously and the device temperature data indicates that a temperature value of a CPU as “50”. In this example, the temperature deviation of the CPU may be determined as “normal”. In another example, consider that the device usage data indicates that the electronic device is executing 3 applications simultaneously and the device temperature data indicates that the temperature value of the CPU as “50”, In this example, the temperature deviation of the CPU may be determined as “heated”, In both the example scenarios, even though the temperature value of the CPU is same, the temperature deviation is different due to difference in the load on the CPU. Thus, examples described herein may consider different device usage factors to determine the sound deviation or the temperature deviation of the components.

The above-described examples are for the purpose of illustration. Although the above examples have been described in conjunction with example implementations thereof, numerous modifications may be possible without materially departing from the teachings of the subject matter described herein. Other substitutions, modifications, and changes may be made without departing from the spirit of the subject matter. Also, the features disclosed in this specification (including any accompanying claims, abstract, and drawings), and/or any method or process so disclosed, may be combined in any combination, except combinations where some of such features are mutually exclusive.

The terms “include,” “have,” and variations thereof, as used herein, have the same meaning as the term “comprise” or appropriate variation thereof. Furthermore, the term “based on”, as used herein, means “based at least in part on.” Thus, a feature that is described as based on some stimulus can be based on the stimulus or a combination of stimuli including the stimulus. In addition, the terms “first” and “second” are used to identify individual elements and may not meant to designate an order or number of those elements.

The present description has been shown and described with reference to the foregoing examples. It is understood, however, that other forms, details, and examples can be made without departing from the spirit and scope of the present subject matter that is defined in the following claims.

What is claimed is:

1. A non-transitory machine-readable storage medium encoded with instructions that, when executed by a processor of a computing device, cause the processor to:
receive device usage data associated with an electronic device;
receive sensor data indicative of an internal state of the electronic device, the sensor data comprising first data associated with a first characteristic of the internal state and second data associated with a second characteristic of the internal state;
determine a deviation associated with a component of the electronic device by applying a machine learning model to the device usage data and the sensor data, wherein the deviation is associated with the first characteristic, the second characteristic, or both; and
generate an alert notification based on the determined deviation.

2. The non-transitory machine-readable storage medium of claim 1, wherein instructions to determine the deviation associated with the component comprise instructions to:
apply the machine learning model to the device usage data, the first data and the second data to:
determine the deviation of the component by comparing a difference between the received first data related to the first characteristic of the component and first reference data based on the device usage data;
determine the deviation of the component by comparing a difference between the received second data related to the second characteristic of the component and second reference data based on the device usage data; or
a combination thereof.

3. The non-transitory machine-readable storage medium of claim 1, wherein the device usage data comprises central processing unit (CPU) usage data, application usage data, device charging data, device location data, fan speed data, device usage time data, device age data, or any combination thereof.

4. The non-transitory machine-readable storage medium of claim 1, wherein instructions to determine the deviation associated with the component comprise instructions to:
correlate the device usage data with the first data and the second data; and
determine the deviation associated with the component by applying the machine learning model to the device usage data, the first data, and the second data based on the correlation.

5. The non-transitory machine-readable storage medium of claim 1, wherein the alert notification is to include a recommended action to reduce the deviation associated with the component, replace the component, or a combination thereof, and wherein the alert notification is generated when the determined deviation exceeds a threshold.

6. A non-transitory machine-readable storage medium storing instructions executable by a processor of a computing device to:
obtain historical device usage data and historical sensor data of an electronic device, the historical device usage data comprising processor usage data, device charging data, device usage time, or any combination thereof, and the historical sensor data comprising device sound data and device temperature data;
process the historical device usage data and the historical sensor data to generate a train dataset and a test dataset;
train a set of machine learning models to estimate a sound deviation, a temperature deviation, or both of a component of the electronic device using the train dataset;
test the trained set of machine learning models with the test dataset; and
determine a machine learning model from the set of tested machine learning models to estimate, in real-time, the sound deviation, temperature deviation, or both of the component.

7. The non-transitory machine-readable storage medium of claim 6, further comprising instructions to:
receive real-time device usage data and realtime sensor data associated with the electronic device;
estimate the sound deviation, the temperature deviation, or both associated with the component by analyzing the real-time device usage data and the real-time sensor data using the determined machine learning model;
generate an alert notification based on the sound deviation, the temperature deviation, or both; and
send the alert notification to the electronic device.

8. The non-transitory machine-readable storage medium of claim 6, wherein instructions to train the set of machine learning models comprise instructions to:
train the set of machine learning models to:
classify the historical sensor data to identify data associated with the component; and
estimate the sound deviation, the temperature deviation, or both associated with the component using the classified historical sensor data and the historical device usage data of the train dataset.

9. The non-transitory machine-readable storage medium of claim 6, wherein instructions to determine the machine learning model from the set of tested machine learning models to estimate the sound deviation, the temperature deviation, or both comprise instructions to:
determine the machine learning model having a maximum accuracy from the set of tested machine learning models to:
identify the component of the electronic device that generates sound, temperature, or both using real-time sensor data; and
estimate the sound deviation, the temperature deviation, or both associated with the component for real-time device usage data and the real-time sensor data, wherein the real-time device usage data is to indicate a load on the component that impacts the sound, the temperature, or both associated with the component.

10. The non-transitory machine-readable storage medium of claim 6, further comprising instructions to:
prior to testing the trained set of machine learning models, validate the trained machine learning models to tune an accuracy of the trained machine learning models based on a validation dataset of the processed historical device usage data and the historical sensor data.

11. The non-transitory machine-readable storage medium of claim 6, further comprising instructions to process the historical device usage data and the historical sensor data to generate the train dataset and the test dataset comprises instructions to:
correlate the historical device usage data with the historical sensor data; and
generate the train dataset and the test dataset based on the correlation.

12. An electronic device comprising:
a storage device;
an output device; and
a processor to:
retrieve, from the storage device, sensor data for a period in response to receiving a trigger event, wherein the sensor data comprises device sound data and device temperature data;
apply a machine learning model to the sensor data to:
classify the retrieved sensor data;
identify a component of the electronic device that generates sound, temperature, or both using the classified sensor data;
determine that the sound, temperature, or both associated with the component is to impact a performance of the electronic device; and
in response to the determination, determine a recommended action to reduce the sound, the temperature, or both; and
output an alert notification including the recommended action via the output device.

13. The electronic device of claim 12, further comprising:
a sound sensor to record the device sound data associated with the electronic device, wherein the sound sensor comprises a microphone; and
a temperature sensor to record the device temperature data associated with the electronic device.

14. The electronic device of claim 12, wherein the processor is to:
apply the machine learning model to the sensor data to:
filter the sensor data to remove ambient sound and ambient temperature from the retrieved sensor data; and
classify the filtered sensor data into a group of categories, wherein the sensor data associated with a category in the group of categories belongs to the component of the electronic device.

15. The electronic device of claim 12, wherein the processor is to:
retrieve, from the storage device, device usage data for the period, wherein the device usage data comprises central processing unit (CPU) usage data, application usage data, device charging data, device location data, fan speed, device usage time, device age, or any combination thereof; and
apply the machine learning model to the sensor data and the device usage data to:
determine that the sound, the temperature, or both associated with the component is to impact the performance of the electronic device.
